(19) United States
(12) Patent Application Publication
(10) Pub. No.: US 2008/0142135 A1
(43) Pub. Date: Jun. 19, 2008

(54) Pneumatic tire with decoupling groove

(75) Inventor: Daniel Stephen Mathews, Mount Vernon, IL (US)

Correspondence Address: CONTINENTAL TEVES, INC., ONE CONTINENTAL DRIVE, AUBURN HILLLS, MI, 48326-1581, US

(73) Assignee: Continental Tire North America, Inc.

(21) Appl. No.: 11/639,890

(22) Filed: Dec. 15, 2006

(51) Int. Cl. B60C 11/01

(52) U.S. Cl. 152/209.16

(57) ABSTRACT

In a tire tread with a decoupling groove (38), the edge (36) of the tread rib (32) adjoining the decoupling groove (38) has a wavy contour. The wavy edge (36) provides protection from step-off wear because erosion at one location is confined to the affected wave. The adjacent edge (44) of the decoupler rib (34) may have a complementary wavy contour. In the area of the contact patch, where the vehicle load on the tire deforms the tread, these two edges (36,44) will interlock with each other, thus protecting the outer edge (36) of the tread rib. Instead, the outer edge of the decoupler rib (34) will be subjected to erosion wear. Toward the bottom of the decoupling groove (38), the wavy contour of the edges (36,44) may taper off. The bottom of the decoupling groove (38) can be arranged in a straight circumferential line.

### BACKGROUND OF THE INVENTION

The present invention relates to a tire tread with a circumferential decoupling groove as commonly used on truck steer tires or on other non-drives axles, for instance on trailers.

The use of treads specifically designed for the steer axle of truck tires has been directed to various forms of rib-type tires. This non-driving axle exhibits cornering and turning loads as well as straight line running loads.

High wear erosion is common in the shoulder region of the tread. In order to reduce irregular wear, the use of a laterally located circumferentially continuous rib, a so-called decoupler rib, has been suggested that under normal driving conditions is in contact with the road, the force or pressure exerted by the decoupler rib on the road being less than the force or pressure of the shoulder rib.

U.S. Pat. No. 6,488,062 describes a tire with a decoupler rib separated from the outermost tread rib by a decoupling groove. The edge of the tread rib adjoining the decoupling groove is provided with numerous small sipes that open into the decoupling groove. The intended effect is to further reduce erosive shoulder wear, also called shoulder river wear, tramline wear, or step-off wear, which causes the rib edges to deteriorate and to become irregular and blunt. The sipes are arranged at an angle with respect to the tire's axial direction as well as its radial direction, thus rendering the tire a directional tire.

When a vulcanized tire is removed from its tire mold, there is a tendency for the siping blades to be deformed or even to be pulled out of the mold. From a practical standpoint, therefore, it is difficult to incorporate a large number of sipes at a small distance from each other.

It is therefore the objective of the present invention to provide a tire tread with a decoupling groove and a decoupler rib which, on the one hand, improves the tire's protection from step-off wear and, on the other hand, is easy to manufacture.

### SUMMARY OF THE INVENTION

This objective is achieved by a tire tread with a decoupling groove with the edge of the tread rib adjoining the decoupling groove having a wavy contour. The wavy edge provides protection from step-off wear because erosion at one location is confined to the affected wave, in a similar way as fraying of fabric is limited if zigzag scissors are used for cutting.

Such a wavy contour is less complicated to manufacture than sipes because the wavy shape is engraved in the tire mold, and no blades need to be inserted.

An added benefit is achieved by providing the adjacent edge of the decoupler rib with a complementary wavy contour. In the area of the contact patch, where the vehicle load on the tire deforms the tread, these two edges will interlock with each other, thus eliminating the outer edge of the tread rib, also called shoulder rib. Instead, the outer edge of the decoupler rib will be subjected to erosion wear. Since the decoupler rib itself does not contribute to the tire tread performance, wear of the decoupler rib is favorable over step-off wear on the shoulder rib. Due to the decoupling groove, any step-off wear on the decoupler rib cannot progress into the shoulder rib.

Toward the bottom of the decoupling groove, the wavy contour of the edges may taper off. The bottom of the decoupling groove can be arranged in a straight circumferential line. River wear is the greatest when the tire is new, i.e. when a tire has a high tread depth. As the tread wears down, the grooves become shallower with respect to the tread surface, and the relative movement of the tread surface with respect to the lower tread portions becomes smaller, thus reducing erosive wear. A wavy contour to reduce river wear becomes unnecessary at lower tread depths.

A narrower decoupling groove may enhance the interlocking function. Depending on the priorities, the width of the decoupling groove and be chosen based on the intended functionality.

### BRIEF DESCRIPTION OF THE DRAWINGS

In the drawings,

FIG. 1 is a schematic cross-sectional partial view of a tire according to the present invention.

FIG. 2 is a dimensional partial view of a tire tread as shown in FIG. 1;

FIG. 3 is a dimensional partial of a tire tread with a decoupling groove having opposite interlocking wavy edges; and

FIG. 4 is a dimensional partial showing a different embodiment of a tire tread with a decoupling groove having opposite interlocking wavy edges.

### DETAILED DESCRIPTION OF THE DRAWINGS

With reference to FIG. 1, a partial radial cross section of the pneumatic radial tire, for example for use on steering axles or trailer axles, is illustrated.

The tire tread 10 comprises a shoulder rib 12 extending in the circumferential direction of the tire and a decoupler rib 14 extending in parallel thereto, separated from each other by a decoupling groove 18. The wall 20 connecting the decoupling groove 18 with the shoulder rib 12 is approximately twice as high as the wall 22 connecting the decoupling groove 18 with the decoupler rib 14. Accordingly, the ridge 24 of the decoupler rib 14 is radially recessed in comparison with the shoulder rib 14. During normal driving conditions, the decoupler rib is not in contact with the road. However, the invention is not limited to this arrangement and also extends to tires with decoupler ribs contacting the road surface.

The edge 16 of the shoulder rib 12 has a wavy contour so that the angle between the walls 20 and 22 varies in the circumferential direction of the tire.

All other elements of the tire, including the belts 26, are only shown for illustrative purposes and may be arranged differently in an actual tire.

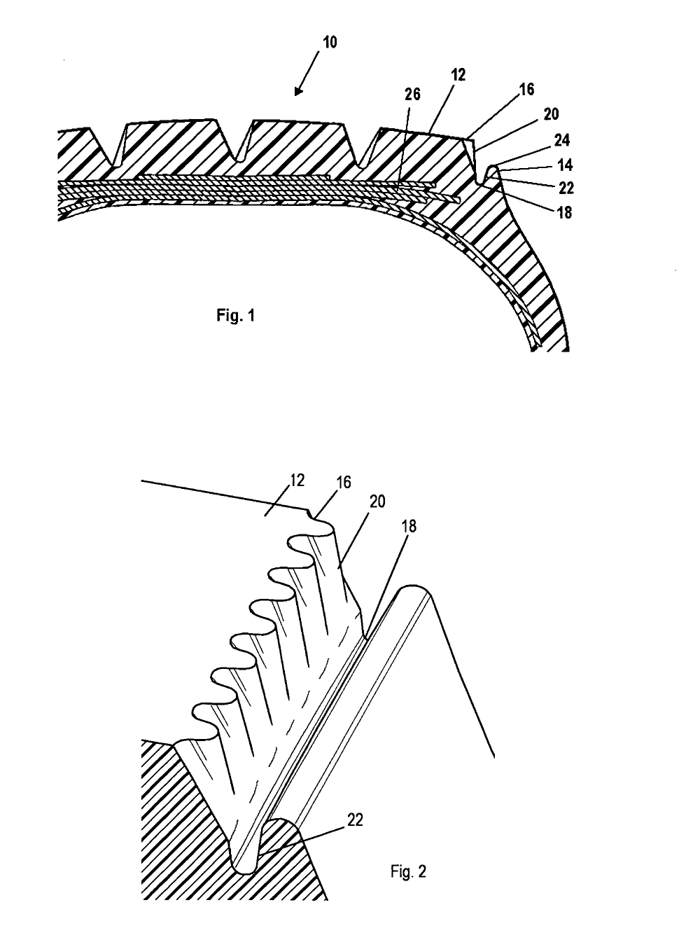

It is evident in the view of FIG. 2, which shows the same embodiment as FIG. 1, that on the side of the shoulder rib 12, the edge 16 of the wall 20 describes a sinusoidal line at the tread surface. The amplitude of the sinusoidal contour diminishes toward the bottom of the decoupling groove 18. Near its bottom, the decoupling groove 18 constitutes a straight groove with parallel walls 20 and 22 and a rounded bottom. The decoupling groove 18 is relatively wide in order to prevent stone retention in the groove, which would compromise its function.

River wear mostly occurs during the first 60,000 miles of a tire life. After that, further preventive measures become unnecessary. Therefore, the wavy contour of the edge 16 tapers off toward the bottom of the decoupling groove 18. Once the tread is worn down by a significant amount, the wavy contour disappears.

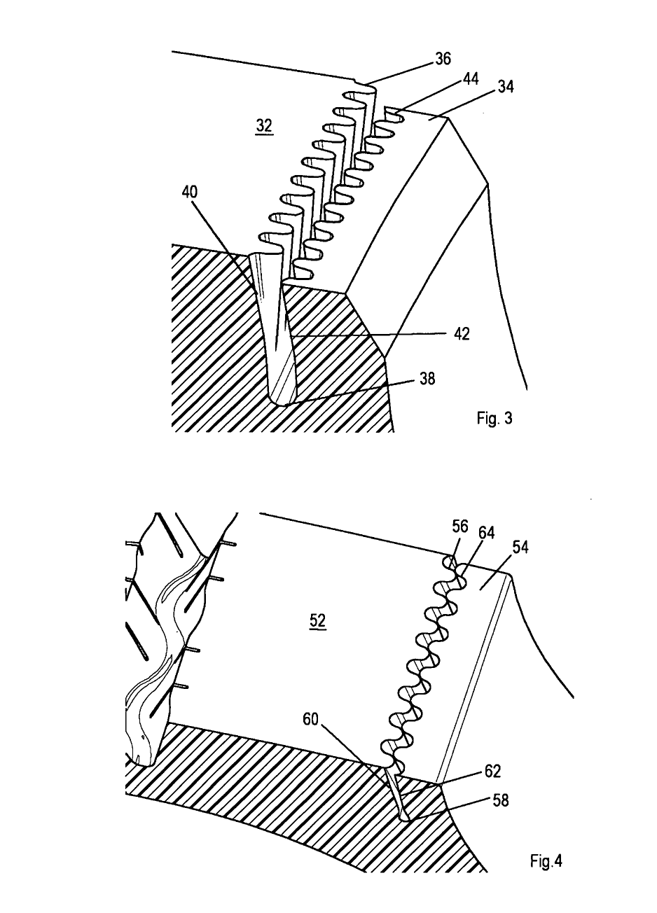

FIG. 3 shows a different embodiment of the invention. On the side of the shoulder rib 32, the edge 36 of the wall 40 describes a sinusoidal line at the tread surface, similar to the embodiment of FIGS. 1 and 2. In FIG. 3, however, the edge 44 of the decoupler rib 34 has a wavy contour as well. It is arranged in a complementary shape to the edge 36 so that the sinusoidal contours work together like interlocking teeth when the tread portion is under load and the decoupler groove narrows at its top due to the tire deformation. Just like the edge 36 of the shoulder rib 32, the amplitude of the sinusoidal contour of the decoupler rib 34 tapers off vertically toward the bottom of the decoupling groove 38 along the wall 42 of the decoupler rib 34.

The radial height of the decoupler rib 34 is slightly recessed with respect to the tread surface of the shoulder rib 32. When a respective tread section is under load, the tread surface will nearly align with the surface of the decoupler rib 34 due to the depression of the tread, and the gap of the decoupling groove will narrow to a degree that the sinusoidal contours interlock. The decoupler rib 34 has a tapered outer edge to reduce erosion wear along this edge.

FIG. 4 shows an embodiment sharing many features with the example of FIG. 3. The differences are as follows: The decoupling groove 58 shown in FIG. 4 is narrower than in the previous examples. To prevent tears, it has a teardrop-shaped bottom contour with a diameter slightly greater than the width of the remainder of the decoupling groove 58. Due to the smaller width of the decoupling groove 58, wall 60 of the shoulder rib 52 and wall 62 of the decoupler groove 54 are closer together, and the sinusoidal contours of their edges 56 and 64, respectively, overlap by a small degree even without load acting on the tire tread. The bottom of the decoupler groove can describe a straight line as in the previous examples or a sinusoidal curve. In the first case, the sinusoidal contours taper off, in the latter case, they remain the same along the walls 60 and 62 toward the teardrop bottom of the decoupling groove 58.

Once the tread portion is under load, the two edges only make a minor movement toward each other to effect a complete closing of the decoupling groove. Accordingly, the height difference between the shoulder rib 52 and the decoupler rib 54 is smaller as well compared to the embodiment of FIG. 3.

What is claimed is:

1. A pneumatic tire with a tread (10) comprising a shoulder rib (12) extending in circumferential direction and separated from a circumferentially extending decoupler rib (14) by means of a decoupling groove (18) with two walls (20,22), one of which (20) connects the decoupling groove (18) with the shoulder rib (12) and the other one of which (22) connects the decoupling groove (18) with the decoupler rib (14), wherein the wall (20) connecting the decoupling groove (18) with the shoulder rib (12) has a wavy edge contour.

2. The tire according to claim 1, wherein the wall (22) connecting the decoupling groove (18) with the decoupler rib (14) has a wavy edge contour complementing the edge contour of the other wall (20).

3. The tire according to claim 2, wherein the tire has a relaxed shape in which the two wavy contours overlap with each other.

4. The tire according to claim 1, wherein, in axial direction with respect to the tire geometry, the wave contour has an amplitude, which diminishes toward the bottom of the decoupling groove.

5. The tire according to claim 1, wherein the decoupler rib (14) is radially recessed in comparison with the shoulder rib.
